(19) United States
(12) Patent Application Publication
(10) Pub. No.: US 2004/0249003 A1
(43) Pub. Date: Dec. 9, 2004

(54) Method for the production of expandable polystyrene

(76) Inventors: Achim Datko, Nubloch (DE); Klaus Hahn, Kirchheim (DE); Harald Larbig, Ludwigshafen (DE); Karl-Heinz Batscheider, Mutterstadt (DE)

Correspondence Address: Keil & Weinkauf, 1350 Connecticut Avenue NW, Washington, DC, 20036, US

(21) Appl. No.: 10/489,278

(22) PCT Filed: Sep. 5, 2002
(86) PCT No.: PCT/EP02/09924

(51) Int. Cl. C08J 9/16

(52) U.S. Cl. 521/56

(57) ABSTRACT

The invention relates to a process for the production of bead-form, expanded polystyrene by suspension polymerization of styrene in the presence of from 1 to 5% by weight of a hydrocarbon having from 4 to 6 carbon atoms and from 0.5 to 3.5% by weight of a saturated, aliphatic hydrocarbon having a boiling point above 70° C., but in the absence of a chain-transfer agent which causes a reduction in the molecular weight of the polystyrene.

The invention relates to a process for the preparation of bead-form, expandable polystyrene by polymerization of styrene in aqueous suspension in the presence of blowing agents and expansion assistants.

Foams based on styrene polymers have been known for some time and have been widely described in the literature. Particular importance is attached to polystyrene molded foams, which are produced by expanding polystyrene beads containing blowing agents and subsequently fusing these foamed beads to give slabs, moldings and other foamed articles.

The expandable polystyrene beads containing blowing agent are usually produced by suspension polymerization, in which monomeric styrene is suspended and polymerized in aqueous solution. The blowing agent is usually added during the polymerization, but it is also possible to add the blowing agent to the polystyrene beads in a subsequent process step. Preferred blowing agents are C₄-C₆-hydrocarbons, in particular pentanes. In industrial processes, these are employed in amounts of from 6 to 7% by weight, based on the monomers. For environmental protection reasons, it is endeavored to reduce the amount of pentane; however, this is only possible, according to U.S. Pat. No. 5,112,875, if the process is carried out in the presence of chain-transfer agents, for example mercaptans, which reduce the molecular weight of the polystyrene formed. This is because it has been found that during foaming of relatively high-molecular-weight polystyrene using less blowing agent, the expandability of the polystyrene, i.e. the degree of expansion of the foam beads, becomes too low. On the other hand, however, EPS beads based on low-molecular-weight polystyrene tend to stick and shrink during foaming. This is also the case if, in accordance with EP-A 758 667, from 0.01 to 1.0% by weight of a saturated hydrocarbon having a boiling point above 70° C. are added as additional expansion assistant and the process is carried out in the presence of from 0.05 to 0.5% by weight of dimeric α-methylstyrene as chain-transfer agent. The addition of larger amounts of expansion assistant is advised against in EP-A 758 667, since these, as plasticizer, would cause undesired shrinkage of the expanded beads.

WO 00/15703 describes a process for the production of EPS beads by suspension polymerization of styrene in the presence of from 0.5 to 4% by weight of a hydrocarbon blowing agent and, if desired, in the presence of white oil and a chain-transfer agent. The EPS beads are foamed in a first step to bulk densities of from 0.2 to 0.6 g/m³, i.e. their expandability is very low.

It is an object of the present invention to develop a process for the production of EPS beads having a relatively low blowing agent content and good expandability which can nevertheless be converted into foam beads of low tack and low shrinkage.

We have found that this object is achieved by carrying out the polymerization in the presence of

A. from 1 to 5% by weight of a saturated, aliphatic hydrocarbon having from 4 to 6 carbon atoms and having a boiling point below 70° C. as blowing agent, and

B. from 0.5 to 3.5% by weight of a saturated, aliphatic hydrocarbon having a boiling point above 70° C. as expansion assistant,

but in the absence of a chain-transfer agent which causes a reduction in the molecular weight of the polystyrene.

The EPS according to the invention comprises, as polymer matrix, homopolystyrene or styrene copolymers with up to 20% by weight, based on the weight of the polymers, of ethylenically unsaturated comonomers, in particular alkylstyrenes, divinylbenzene, acrylonitrile or α-methylstyrene.

As described in EP-A 758 667, commercially available styrene may contain ethylbenzene and cumene as impurities. Since these substances are not recognized as safe, a styrene which contains not more than 1000 ppm, preferably not more than 500 ppm, of ethylbenzene and cumene should be employed wherever possible.

The suspension polymerization is carried out in the presence of suspension stabilizers and conventional styrene-soluble polymerization initiators. Besides molecular colloids, such as polyvinyl alcohol (PVA) and polyvinylpyrrolidone (PVP), the suspension stabilizers employed here are usually low-solubility salts, such as Mg₂P₂O₇ and Ca₃(PO₄)₂ (so-called Pickering salts), in combination with an extender, such as dodecylbenzenesulfonate. In order to control the bead size, small amounts of inorganic alkali metal salts, for example sulfates, chlorides, carbonates or hydrogencarbonates, may additionally be added. The conventional free-radical polymerization initiators, for example dibenzoyl peroxide, tert-butyl perbenzoate, tert-butyl peroxy-2-ethylhexanoate or dicumyl peroxide, are added in the polymerization.

In accordance with the invention, the following assistants are added before, during or after the polymerization:

A. from 1 to 5% by weight, preferably from 2 to 4% by weight, of a C₄-C₆-hydrocarbon having a boiling point below 70° C. as blowing agent. Examples of suitable blowing agents are butane, isobutane, n-pentane, isopentane, neopentane, cyclopentane and hexane, and mixtures thereof. n-Pentane is preferred.

B. From 0.5 to 3.5% by weight, preferably from 1.1 to 3.0% by weight, and in particular from 1.6 to 3.0% by weight, based on styrene, of a saturated hydrocarbon having a boiling point above 70° C., preferably above 150° C. and in particular above 200° C. If the boiling point is very low, the expansion assistant diffuses out of the expandable polystyrene beads too quickly and can likewise contribute to environmental pollution. It has been found that—in contrast to the warning in EP-A 758 667—even larger amounts of expansion assistant did not result in shrinkage of the expanded beads if small amounts of blowing agents are used in accordance with the invention. Particularly preferred expansion assistants are light mineral oils having a boiling range of from 250° C. to 300° C. and white oils having a boiling range of from 430 to 540° C.

It is essential that the polymerization is carried out in the absence of a chain-transfer agent which causes a reduction in the molecular weight. The term “reduction in the molecular weight” here is taken to mean a decrease in the viscosity by more than 2 ml/g, preferably by more than 1 ml/g.

The styrene polymers may also comprise conventional additions of other substances which provide the expandable products with certain properties. Mention may be made by way of example of flame retardants based on organic bromine or chlorine compounds, such as trisdibromopropyl phosphate and hexabromocyclododecane, and synergists for flame retardants, such as dicumyl; agents for reducing the thermal conductivity of the foams, such as graphite, carbon black or aluminum; furthermore antistatics, stabilizers, dyes, lubricants, fillers and substances which have an anti-adhesive action during pre-foaming, such as zinc stearate, melamine-formaldehyde condensates or silicic acid, and agents for shortening the demolding time during final expansion, for example glycerol esters or hydroxycarboxylic acid esters. The additives may be homogeneously distributed in the beads or may be in the form of a surface coating, depending on the intended effect.

Correspondingly, the additives are added in the process according to the invention or applied subsequently to the expandable styrene polymers.

When the polymerization is complete, the bead-form, expandable styrene polymers obtained in the process according to the invention are separated from the aqueous phase, washed and dried in a known manner.

The invention furthermore relates to a bead-form, expandable polystyrene having a content of

A. from 0.5 to 3.0% by weight of a saturated, aliphatic hydrocarbon having from 4 to 6 carbon atoms and having a boiling point below 70° C.,

B. from 0.5 to 3.5% by weight, preferably from 1.1 to 3.0% by weight, of a saturated, aliphatic hydrocarbon having a boiling point above 70° C., preferably above 200° C., and

C. less than 0.02% by weight, preferably less than 0.002% by weight, of a chain-transfer agent which causes a reduction in the molecular weight M_{w} of the polystyrene.

The EPS beads according to the invention generally have a diameter of from 0.2 to 4 mm. They can be pre-foamed by conventional methods, for example using steam, in one step to give foam beads having a diameter of from 0.1 to 2 cm and a bulk density of less than 0.1 g/cm³; in the case of two-step foaming, bulk densities of from 0.005 to 0.05 g/cm³ are achieved.

The pre-foamed beads can then be foamed by conventional methods to give foam moldings having a density of from 0.005 to 0.1 g/cm³.

The EPS beads produced in accordance with the invention are distinguished by good processing constancy, namely through a uniformly high degree of expansion, a uniformly high foaming rate and uniformly short demolding times during molding production. In addition, the tendency to stick during the pre-foaming process is low.

In particular, however, the EPS beads comprise low-boiling hydrocarbons, which are relatively unproblematic.

The percentages quoted in the examples relate to the weight.

### EXAMPLE 1

482 l of demineralized water and 45 kg of a freshly precipitated suspension of magnesium pyrophosphate, prepared from a solution of 1.852 kg of magnesium sulfate MgSO₄ in 9.0 l of demineralized water and a solution of 0.988 g of sodium pyrophosphate Na₄P₂O₇ in 33.1 l of demineralized water, were introduced into a pressure-tight 1 m³ stirred-tank reactor.

An organic phase comprising 562 kg of styrene in which 5.62 kg of polystyrene had been dissolved, 11.24 kg of white oil (2%, based on styrene) (Winog 70 from Wintershall), 0.562 kg of polyethylene wax (Polywachs 2000 Micro from BASF), 2.25 kg of dicumyl peroxide and 0.6 kg of dibenzoyl peroxide (75%) was added thereto. The reaction mixture was heated to 95° C. over the course of 1.5 hours. The temperature was then raised to 137° C. over the course of 3.5 hours, with 5.06 kg of (1.3%) emulsifier K 30 (Bayer) being added after 150 minutes and 19.67 kg of pentane (3.5%, based on styrene) being added over a period of 40 minutes after 175 minutes. Finally, the mixture was polymerized to completion at 137° C. for 2.5 hours. The beads obtained were centrifuged off and dried. They comprised 2.9% of pentane, 130 ppm of residual styrene and 500 ppm of ethylbenzene.

The viscosity number (measured in accordance with DIN 51562, Part 2) was 77 ml/g. During pre-foaming with steam, only 7% of the foam beads had stuck, which is still acceptable in a pilot-plant experiment.

### EXAMPLE 2 (COMPARISON)

Example 1 was repeated, but with (in accordance with Example 5 of EP-A 758 667) 0.25% of dimeric α-methylstyrene and 0.315% of white oil being added. The EPS beads obtained had a pentane content of 3.0% and a viscosity number of 58 ml/g; during pre-foaming, 21% of the foam beads had stuck.

### EXAMPLE 3

Example 1 was repeated, but only 1% of white oil was added. The pentane content and viscosity number were the same as in Example 1, and the fusing of the foam beads during molding production was less than in Example 1.

We claim:

1. A process for the preparation of bead-form expandable polystyrene (EPS) by polymerization of styrene, if desired together with up to 20% by weight of conventional comonomers, in aqueous suspension in the presence of suspension stabilizers and conventional styrene-soluble polymerization initiators, and in the presence of
A. from 1 to 5% by weight, based on the monomers, of a saturated, aliphatic hydrocarbon having from 4 to 6 carbon atoms and having a boiling point below 70° C. as blowing agent, and
B. from 0.5 to 3.5% by weight, based on the monomers, of a saturated, aliphatic hydrocarbon having a boiling point above 70° C. as expansion assistant,
which comprises carrying out the polymerization in the absence of a chain-transfer agent which causes a reduction in the molecular weight of the polystyrene.

2. A process for the preparation of EPS as claimed in claim 1, wherein the polymerization is carried out in the presence of from 2 to 4% by weight of the blowing agent A and in the presence of from 1.1 to 3.0% by weight of the expansion assistant B.

3. A process for the preparation of EPS as claimed in claim 1, wherein the expansion assistant B is a light mineral oil having a boiling range of from 250° C. to 300° C.

4. A process for the preparation of EPS as claimed in claim 1, wherein the expansion assistant is a white oil having a boiling range of from 430° C. to 540° C.

5. Bead-form expandable polystyrene which has a content of
A. from 0.5 to 3.0% by weight, based on polystyrene, of a saturated, aliphatic hydrocarbon having from 4 to 6 carbon atoms and having a boiling point below 70° C.,
B. from 0.5 to 3.5% by weight of a saturated, aliphatic hydrocarbon having a boiling point above 70° C., and
C. less than 0.04% by weight of a chain-transfer agent which causes a reduction in the molecular weight of the polystyrene.

6. The use of EPS beads as claimed in claim 5 for the production of polystyrene foam beads, wherein the EPS beads are expanded in one step to a bulk density of less than 0.1 g/cm³ using steam.
